(19) United States
(12) Patent Application Publication
(10) Pub. No.: US 2005/0206492 A1
(43) Pub. Date: Sep. 22, 2005

(54) Plug-in fuse

(76) Inventor: Cheng-Pao Chao, Taipei Hsien (TW)

Correspondence Address: CHENG-PAO CHAO, 235 P.O. BOX 10-69, Taipei, TW

(21) Appl. No.: 10/803,937

(22) Filed: Mar. 19, 2004

(51) Int. Cl. H01H 85/02

(52) U.S. Cl. 337/198

(57) ABSTRACT

A plug-in fuse comprises an upper cover plate two conductive sheets are formed by conductive material, an outer side of an upper edge of each conductive sheet; an inner upper side of each conductive sheet having an L shape notch; a fuse installed between the two conductive sheets; a casing; a light emitting unit installed between the conductive wires. When the fuse is normal, most of the current flows through the two conductive wires and the two conductive sheets, but only a smaller amount of current flows through the light emitting unit; thus the light emitting unit will not light up; if the current is overload, the current will flow through the light emitting unit to light up the light emitting unit.

### FIELD OF THE INVENTION

The present invention relates to fuses, and particularly to a plug-in fuse, wherein the fuse and the light emitting unit can be tightly fixed to the conductive sheets so that it is difficult to be detached. As the fuse has fault, the light emitting unit will light up so as to alert the users. As a result, the fuse can be repaired quickly.

### BACKGROUND OF THE INVENTION

Referring to FIG. 1, a prior art fuse is illustrated. In this prior art, the conductive sheets k and k1 have flat walls. The conductive sheets k and k1 adhere to the inner walls of the casing. Each conductive sheet k, k1 has a through hole h, h1 so that when the fuse is pulled out, the conductive sheet k, k1 can be tightly fixed to the wall. When the fuse breaks, the current cannot flow through the fuse so that the device cannot work. However the user must check the element of the electronic device. This is time and labor consumed.

### SUMMARY OF THE INVENTION

Accordingly, the primary object of the present invention is to provide a plug-in fuse which comprises an upper cover plate two conductive sheets are formed by conductive material, an outer side of an upper edge of each conductive sheet; an inner upper side of each conductive sheet having an L shape notch; a fuse installed between the two conductive sheets; a casing; a light emitting unit installed between the conductive wires. When the fuse is normal, most of the current flows through the two conductive wires and the two conductive sheets, but only a smaller amount of current flows through the light emitting unit; thus the light emitting unit will not light up; if the current is overload, the current will flow through the light emitting unit so as to the light emitting unit lights up.

The various objects and advantages of the present invention will be more readily understood from the following detailed description when read in conjunction with the appended drawing.

### BRIEF DESCRIPTION OF THE DRAWINGS

FIG. 1 is an assembled perspective view of the present invention.

FIG. 2 is a plane exploded view of the present invention.

FIG. 3 is an assembled perspective view of the present invention.

FIG. 4 is a cross sectional view of the present invention.

FIG. 5 is a perspective view showing a state of the present invention, where the fuse does not break.

FIG. 6 is a perspective view showing a state of the present invention, where the fuse has broken.

### DETAILED DESCRIPTION OF THE INVENTION

In order that those skilled in the art can further understand the present invention, a description will be described in the following in details. However, these descriptions and the appended drawings are only used to cause those skilled in the art to understand the objects, features, and characteristics of the present invention, but not to be used to confine the scope and spirit of the present invention defined in the appended claims.

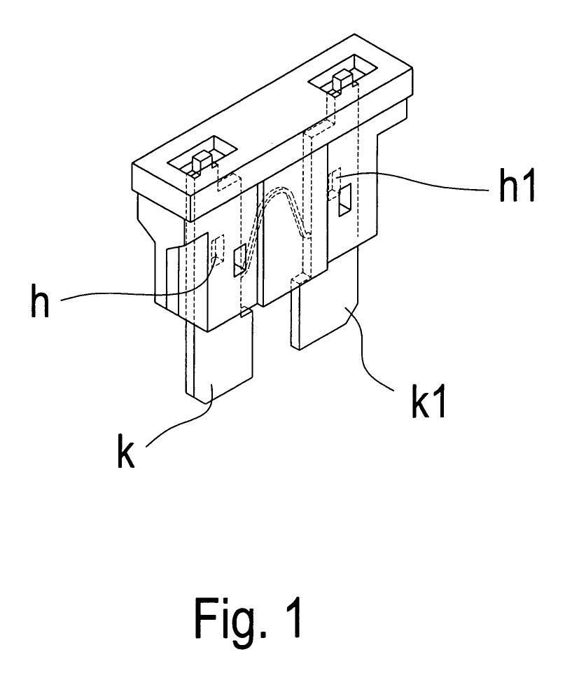

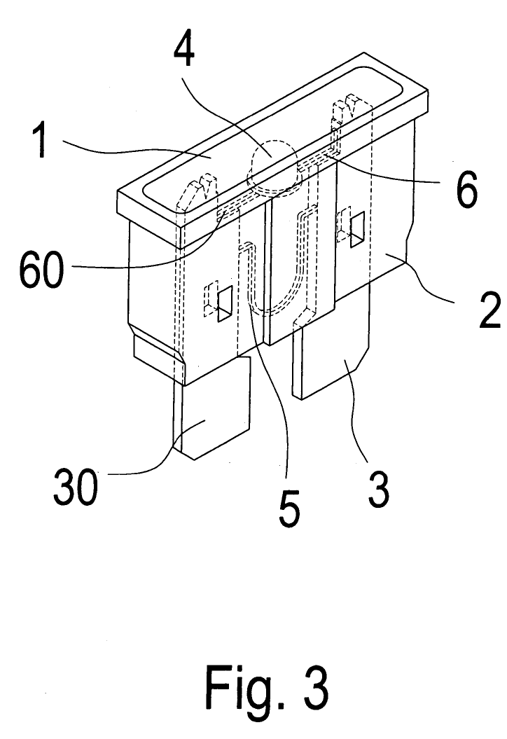

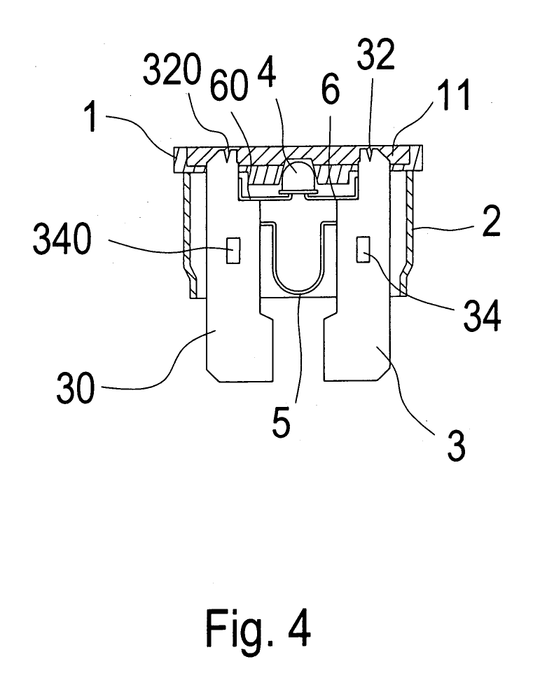

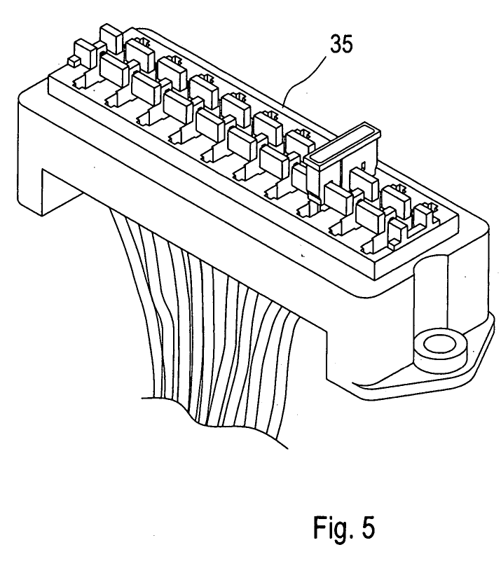

With reference to FIGS. 1 to 5, the plug-in fuse of the present invention is illustrated. The plug-in fuse comprises the following elements.

An upper cover plate 1 has two ends. Each end has a respective retaining seat 11, 110. The retaining seats 11, 110 have respective chamfered edges 12, 120.

Two conductive sheets 3, 30 are formed by conductive material. An outer side of the upper edge of each conductive sheet 3, 30 is formed with a chamfered edge 31, 310, respectively. Each of the conductive sheets 3, 30 has a retaining plate 33, 330 and a through hole 34, 340. Each of the conductive sheet 3, 30 is connected to a respective conductive wire 6, 60. An inner upper side of each conductive sheet 3, 30 has an L shape notch 33, 330. The conductive wires 6, 60 are welded to the L shape notches 33, 330 so as to form welding portions 41.

A fuse 5 is installed between the two conductive sheets 3, 30. A middle part of the fuse 5 is bent downwards with a cambered shape so as to increase the receiving space.

A casing 2 is included. An upper portion of the casing 2 is formed with a receiving chamber 21. The casing 2 has two retaining grooves 22, 220 at two sides of the receiving chamber 21 for receiving the two conductive sheets 3, 30 by using the retaining plates 33, 330 and the through holes 34, 340. Each of the retaining grooves 22, 220 has a positioning hole 23, 230.

A light emitting unit 4 is installed between the conductive wires 6, 60. Normally, most of the current flows through the two conductive wires 6, 60 and the two conductive sheets 3, 30, but only a smaller amount of current flows through the light emitting unit 4. Thus the light emitting unit 4 will not light up. If the current is overload, the current will flow through the light emitting unit 4 so as to light up the light emitting unit 4.

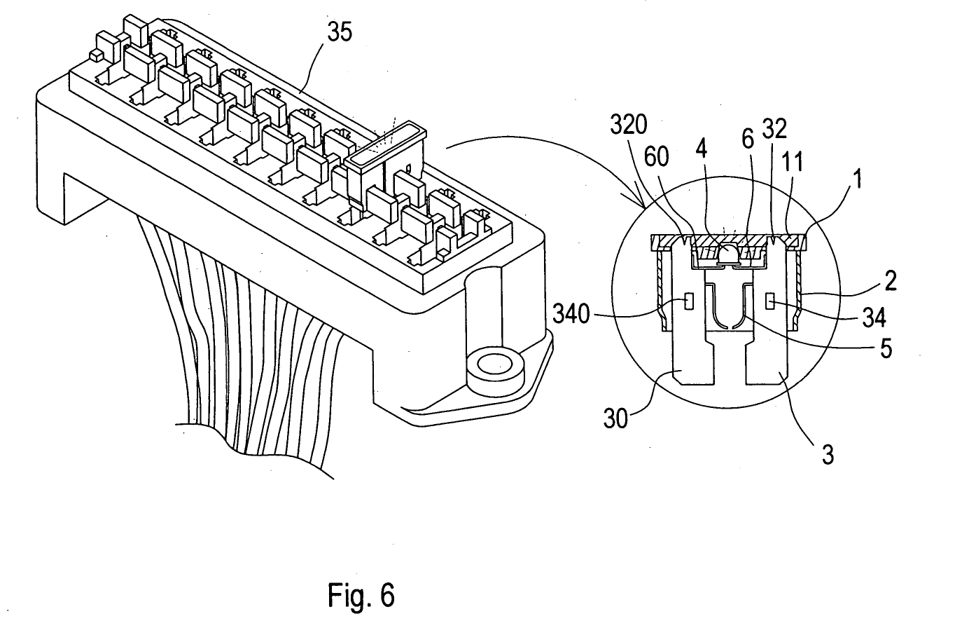

With reference to FIG. 6, in the present invention, the conductive wires 6 and 60 are welded to the two L shape notches 33, 330 so that the conductive wires 6 are tightly adhered to the conductive sheets 3, 30. Thereby it is better than the prior art, in the prior art, the conductive wires 6, 60 will strip due to oxidization. Furthermore, the chamfered edges 12, 120 protect the light emitting unit 4 by smooth contact. By the two retaining seats 10, 110 and the two retaining plates 33, 330, the two conductive wires 6, 60 are tightly fixed therein so that the conductive wires 6, 60 are protected.

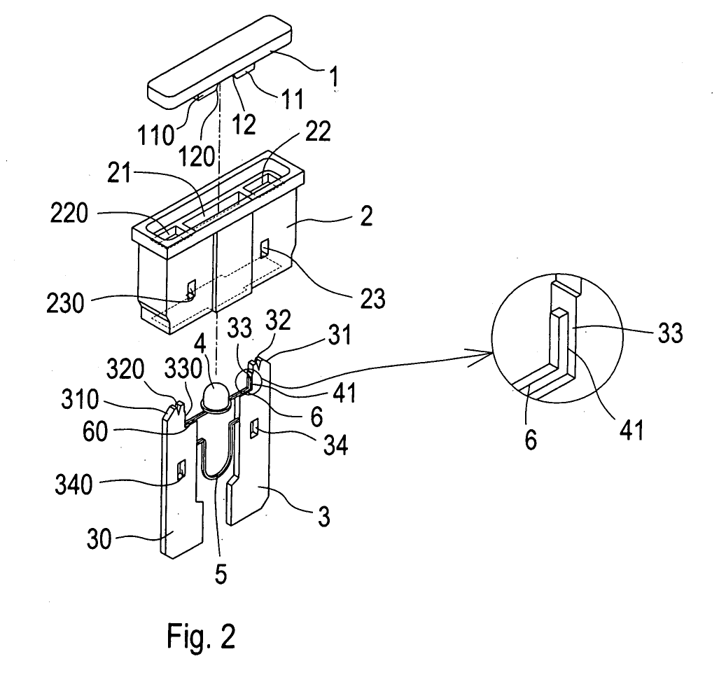

Moreover, as shown in FIG. 2, the conductive sheets 3, 30 can have respective V shape notches 32, 320 at upper sides thereof so that when the conductive sheets 3, 30 are assembled to the upper cover plate 1, the tip portions of the conductive sheets 3, 30 will tightly combine with the upper cover plate 1.

Advantages of the present invention will be described herein. The fuse and the light emitting unit can be tightly fixed to the conductive sheets so that it is difficult to be detached. As the fuse has fault, the light emitting unit will light up to alert the users. As a result, the fuse can be repaired quickly.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

1. A plug-in fuse comprising:
an upper cover plate having two ends; each end having a respective retaining seats; the retaining seats having respective chamfered edges;
two conductive sheets being formed by conductive material, an outer side of an upper edge of each conductive sheet being formed with a chamfered edge, respectively; each of the conductive sheets having a retaining plate and a first through hole; each of the conductive sheet being connected to a respective conductive wire; an inner upper side of each conductive sheet having an L shape notch; the conductive wires being welded to the L shape notches;
a fuse installed between the two conductive sheets;
a casing; an upper portion of the casing being formed with a receiving chamber; the casing having two retaining grooves at two sides of the receiving chamber for receiving the two conductive sheets by using the retaining plates and the through holes; each of the retaining grooves having a positioning hole; and
a light emitting unit installed between the conductive wires;
wherein when the fuse is normal, most of the current flows through the two conductive wires and the two conductive sheets, but only a smaller amount of current flows through the light emitting unit; thus the light emitting unit will not light up; if the current is overload, the current will flow through the light emitting unit so as to the light emitting unit lights up.

2. The plug-in fuse as claimed in 1, wherein the fuse is bent for increasing a space for receiving the light emitting unit.

3. The plug-in fuse as claimed in 1, wherein an inner upper side of each conductive sheet has an L shape notch; the conductive wires is welded to the L shape notches so as to form welding portions.

4. The plug-in fuse as claimed in 1, wherein each of the conductive sheets has a V shape notch at upper side thereof so that when the conductive sheets are assembled to the upper cover plate, tip portions of the conductive sheets formed by the V shape notches will tightly combine with the upper cover plate.

5. The plug-in fuse as claimed in 1, wherein the retaining seats having respective chamfered edges; the chamfered edges protect the light emitting unit by smooth contact.
